(19) United States
(12) Patent Application Publication
(10) Pub. No.: US 2024/0042699 A1
(43) Pub. Date: Feb. 8, 2024

(54) ADDITIVE MANUFACTURING METHOD WITH BUILD MATERIAL CONTROL AND APPARATUS

(71) Applicant: Q.BIG 3D GMBH, Aalen (DE)

(72) Inventors: Dennis HERRMANN, Aalen (DE); Michael HEEL, Westhausen (DE); Katja SCHLICHTING, Aalen (DE)

(21) Appl. No.: 18/282,502

(22) PCT Filed: Mar. 10, 2022
(86) PCT No.: PCT/EP2022/056260

§ 371 Date: Sep. 15, 2023

(30) Foreign Application Priority Data
Mar. 16, 2021 (EP) 21163009.0

(51) Int. Cl. B29C 64/393; B29C 64/209; B29C 64/343; B33Y 50/02; B29C 64/245

(52) U.S. Cl. CPC B29C 64/393; B29C 64/209; B29C 64/343; B33Y 50/02; B29C 64/245; B33Y 30/00

(57) ABSTRACT

A method for producing a solid object using a modeling apparatus includes depositing a build material with an extruder head (1) onto a build surface (2) on predefined areas. The build material quantity applied to the build surface is measured (4), preferably during the build material is deposited onto the build surface, or after each level of build material has been deposited on the build surface, or measuring a force applied to the build surface. Preferably, the build material quantity deposited onto the build surface (2) is compared with the build material projected to be deposited onto the build surface during deposition. Build material deposition is controlled (12) accordingly.

### CLAIM OF PRIORITY

This application is a national phase filing under 35 USC § 371 from PCT Patent Application Serial Number PCT/EP2022/056260 filed on Mar. 10, 2022 and claims priority therefrom. This application further claims priority to European Patent Application Number EP 21163009.0 filed on Mar. 16, 2021. International Patent Application Number PCT/EP2022/056260 and European Patent Application Number EP 21163009.0 are each incorporated by reference in its entirety.

### FIELD OF THE INVENTION

The invention relates to additive manufacturing and a method and apparatus comprising control means for building solid form parts.

### BACKGROUND OF THE INVENTION

Additive manufacturing is a technique for producing solid three dimensional parts by selectively building an object according to three dimensional computer/CAD data. Additive manufacturing was originally denoted rapid prototyping and today is often also referred to as 3D printing. A number of processes are meanwhile known like selective laser sintering (SLS), 3D inkjet printing, fused filament fabrication (FFF), fused deposition molding (FDM, multi-jet-modeling (MJM), or stereolithography (STL or SLA).

All these production processes are well-developed techniques, however, there remain a number of issues which have not been solved leading to quality or/and performance issues.

In particular during the extrusion and/or build material deposition process from the material deposition unit, e.g., the extrusion printing head etc., the quantity of build material deposited or solidifying onto the build surface (print bed) often deviates from the projected quantity, projected layer thickness or exact positioning.

Hence it was one object underlying the current application to provide methods and apparatus with improved performance or/and improved quality performance particularly regarding the material deposition, or at least to reduce or eliminate essentially entirely the disadvantages of the known prior art methods and apparatus.

### SUMMARY OF THE DISCLOSURE

In one aspect the disclosure relates to a method for producing a solid object using a modeling apparatus, e.g. a fused deposition modeling (FDM) apparatus, or a multi-jet-modeling (MJM) apparatus, or a fused filament fabrication (FFF) apparatus, or a stereolithography apparatus (STL) apparatus, comprising a build material deposition unit including a nozzle for depositing build material, a build surface, preferably any additional means useful in said method or apparatus, comprising or consisting of the following steps:
a. depositing the build material with the extruder head onto the build surface on predefined areas in a first level;
b. repeating step a.) in a second level and preferably further levels;
c. repeating steps a.) and b.) so long until the solid object is built;
d. measuring the build material quantity applied to the build surface, preferably during the build material is deposited onto the build surface, or after each level of build material has been deposited on the build surface, or measuring a force applied to the build surface;
e. preferably comparing the build material quantity deposited onto the build surface with the build material projected to be deposited onto the build surface during deposition, or for each level of build material deposited onto the build surface;
f. effecting, e.g., reducing, increasing or stopping, the build material deposition based upon step d.) and/or e, or effecting, e.g., initiating or changing, at least process step or parameter.

In another aspect the disclosure relates to a modeling apparatus comprising a build material deposition unit, a build surface, preferably in a build chamber, travelling means for the extruder head and/or the build surface, build material supply means, and a measuring means for build material deposited onto the build surface or a force applied to the build surface, and preferably a control unit.

### BRIEF DESCRIPTION OF THE FIGURES

FIG. 1 illustrates an apparatus and a method according to the disclosure wherein the build material deposited onto the build surface and integrated for effecting a controlled and high quality solid object production.

### DETAILED DESCRIPTION OF THE DISCLOSURE

The object underlying the present application has been solved by a method for producing a solid object using a modeling apparatus, e.g. a fused deposition modeling (FDM) apparatus, or a multi-jet-modeling (MJM) apparatus, or a fused filament fabrication (FFF) apparatus, or a stereolithography apparatus (STL), comprising a build material deposition unit including a nozzle for depositing build material, a build surface, preferably any additional means useful in said method or apparatus, comprising or consisting of the following steps:
a. depositing the build material with the extruder head onto the build surface on predefined areas in a first level;
b. repeating step a.) in a second level and preferably further levels;
c. repeating steps a.) and b.) so long until the solid object is built;
d. measuring the build material quantity applied to the build surface, preferably during the build material is deposited onto the build surface, or after each level of build material has been deposited on the build surface, or measuring a force applied to the build surface;
e. preferably comparing the build material quantity deposited onto the build surface with the build material projected to be deposited onto the build surface during deposition, or for each level of build material deposited onto the build surface;
f. effecting, e.g., reducing, increasing or stopping, the build material deposition based upon step d.) and/or e, or effecting, e.g., initiating or changing, at least process step or parameter.

The object was solved in another aspect by a modeling apparatus comprising a build material deposition unit, a build surface, preferably in a build chamber, travelling means for the extruder head and/or the build surface, build material supply means, and a measuring means for build material deposited onto the build surface or a force applied to the build surface, and preferably a control unit.

The object was solved in another aspect by an algorithm as described here under.

In one aspect the disclosure relates to a method for producing a solid object using a modeling apparatus, e.g. a fused filament fabrication (FFF) apparatus, or a multi-jet-modeling (MJM) apparatus, or a stereolithography apparatus (STL) apparatus, comprising a build material deposition unit including a nozzle for depositing build material, a build surface, preferably any additional means useful in said method or apparatus, comprising or consisting of the following steps:
a. depositing the build material with the extruder head onto the build surface on predefined areas in a first level;
b. repeating step a.) in a second level and preferably further levels;
c. repeating steps a.) and b.) so long until the solid object is built;
d. measuring the build material quantity applied to the build surface, preferably during the build material is deposited onto the build surface, or after each level of build material has been deposited on the build surface, or measuring a force applied to the build surface;
e. preferably comparing the build material quantity deposited onto the build surface with the build material projected to be deposited onto the build surface during deposition, or for each level of build material deposited onto the build surface;
f. effecting, e.g., reducing, increasing or stopping, the build material deposition based upon step d.) and/or e, or effecting, e.g., initiating or changing, at least process step or parameter.

In another aspect the disclosure relates to a modeling apparatus comprising a build material deposition unit, a build surface, preferably in a build chamber, travelling means for the extruder head and/or the build surface, build material supply means, and a measuring means for build material deposited onto the build surface or a force applied to the build surface, and preferably a control unit.

The method according to the disclosure provides the advantage of an integrated quality control in real time. Thus it becomes possible, e.g. to improve or to maintain the solid 3D objects in an advantageous quality range or to save costly build material by stopping a print job in case serious quality issues arise in an automated fashion. Moreover, it is now possible with the advantageous method and apparatus to determining whether there are mechanical collisions e.g. due to human intervention or due to an error in the movement of any of the apparatus means. Show the remaining print time. Measure layer thickness due to surface pressure, especially the first layer thickness. Log the sensor data for later documentation and quality control.

In the following certain terms will be defined and unless specifically defined herein technical terms shall be understood according to the skilled person in the field of additive manufacturing or its subfields.

The term “fused filament fabrication” (FFF) in the sense of the disclosure is to be understood as known in the art. This term includes all extrusion based additive manufacturing processes like fused deposition modelling (FDM), fused granular fabrication (FGF) or laser metal deposition (LMD).

“Multi-Jet-Modeling” (MJM) in the sense of the disclosure is to be understood as known in the art.

“Stereolithography” (STL) in the sense of the disclosure is to be understood as known in the art. The term includes other print processes that are liquid resin based like stereolithography (SLA) or digital light processing (DLP) or related processes in which the printed object adheres to a build platform.

“Selective laser sintering” (SLS) in the sense of the disclosure is to be understood as as known in the art.

“Build material” in the sense of the disclosure is to be understood as any material that can be solidified during the manufacturing process. It can come in the form of filaments, pellets, liquids or slurries. The build material can be applied using a build material deposition unit or in the case of STL related processes the liquid can already be in contact with the build platform. It can be selected from a thermoplastic material such as acrylonitrile butadiene styrene (ABS), polylactic acid (PLA), high-impact polystyrene (HIPS), thermoplastic polyethylene (TPE), polyether ether ketone (PEEK), polyether ketone ketone (PEKK), polyaryl ether ketone (PAEK), polyether imide (PEI), polycarbonate (PC), acrylonitrile styrene acrylate (ASA), polyethylene terephthalate (PET), polyethylene terephthalate glycol (PETG), polybutylene terephthalate (PBT), polyphenylene sulphide (PPS), polyphenyl sulfone (PPSU), polymethyl methacrylate (PMMA), polypropylene (PP), thermoplastic polyurethane (TPU) or/and aliphatic polyamides (PA) or/and a mixture of these materials, or/and a blend of these materials with organic or inorganic additives like glass fibers, carbon fibers, basalt fibers, glass beads, metal particles, ceramics, carbon nano tubes, or/and a thermoset material like photosensitive resins or/and viscoelastic liquids like concrete or chocolate or binders.

“Build material deposition unit” in the sense of the disclosure is to be understood as any known deposition means usually used in FFF, FDM, FGF, LMD, MJM or STL or SLA or DLP methods. In particular, a build material deposition unit can be selected from an extruder print head including preferably a nozzle or a nozzle array for depositing, a radiation source such as a laser or a light emitting diode or a combination of the two.

“Build material deposition unit output position” in the sense of the disclosure is to be understood as the area or a sub-area of the build material deposition unit where the build material exits said unit. In a special embodiment it can be an extruder head nozzle output position.

“Build surface” in the sense of the disclosure is to be understood as the area where the build material is deposited by the build material deposition unit. It may form a “build bed” and is located in the build chamber. The terms build surface and build bed can be used interchangeably.

“Build chamber” in the sense of the disclosure is to be understood as the three-dimensional area wherein the 3D object is printed comprising the build surface. The build chamber can be open, or it can have sidewalls, or/and also have a top cover and/or bottom cover and it may have additional means for changing or maintaining a pre-set temperature within the build chamber. The build chamber may comprise means for a batch or serial production, e.g., a job box that can be taken out in a suitable manner and be exchanged with another job box. It may have a conveyer for continued transport of the solid 3D object.

“Travelling means” in the sense of the disclosure is to be understood as any means useful for making the build material deposition unit or the build surface change the position in the X-, Y- and Z-axis, respectively. The X-, Y- or Z-motion may be realized with more than one actuator that can be controlled individually e.g., to achieve a tilt or twist of the build surface. Such means are known by the skilled person and thus do not need to be explained further in all detail here.

“Build material supply means” in the sense of the disclosure is to be understood as any means which supplies the build material deposition unit with build material.

“Any additional means” in the sense of the disclosure is to be understood as measuring means used to measure the dispensed material or the pressure applied to the built surface.

“Depositing” in the sense of the disclosure is to be understood as the process of providing build material in a useful material state and applying it onto the build surface according to three-dimensional data sets for obtaining the desired solid 3D object.

“Repeating” steps a.) and b.) in the sense of the disclosure is to be understood as applying build material in repeated layers or tracks in a predefined three-dimensional according to a data set until the projected solid 3D object is formed.

“Measuring” the build material quantity in the sense of the disclosure is to be understood as using a measuring means for detecting the actual weight, mass, volume or/and way of deposition, e.g., thickness, angle etc. of application, of build material onto the build surface or prior layers or tracks of build material.

“Projected” to be deposited onto the build surface in the sense of the disclosure is to be understood as e.g., the build material that was calculated according to the 3D data to be deposited onto the build surface or prior layers or tracks of build material in order to obtain the desired solid 3D object.

“Effecting” in the sense of the disclosure is to be understood as any control applied, changed, stopped or initiated in the method according to the disclosure. In particular this can relate to reducing, increasing or stopping the build material deposition or initiating or changing any process parameters, e.g. build material mass, volume, or speed of deposition, traveling speed of any movable parts of the apparatus like build material deposition unit or build surface, temperature control like change—increasing or reducing—the temperature in the build material deposition unit or/and the build chamber or in any of the temperature means like cooling or heating means, or material conveyer.

A “measuring means” in the sense of the disclosure is to be understood as a means capable of measuring any selected from volume or volume difference, mass or mass difference, pressure or pressure difference, force or force difference, tactile changes, projected appearance or projected three dimensional or two dimensional appearance or deviation therefrom. In particular such means can be selected from a weighing means or weighing cell, a balance, a membrane or tactile pressure means, and an imaging system.

A “weighing means” or “weighing cell” or “balance” in the sense of the disclosure can be used interchangeably and is to be understood as any means that can measure a weight or mass or force or weight difference or mass difference or force difference resulting from depositing a material onto a build surface of an additive manufacturing apparatus. It may also be capable and be used to measure a pressure or force difference resulting from a collision between the build material deposition unit like the extrusion print head and the build material already deposited on the build surface or between any other apparatus means or device or apparatus parts. The weighing cell can be used as a single part or in a number of 2, 3, 4, 5, 6, or more or arrays of weighing cells which in another aspect can be interconnected or/and connected to other apparatus means like any motors for traveling of any apparatus parts like the build material deposition unit or heating or cooling units or/and it can be connected with the control unit. In another aspect it can feed into the control means or into other direct control circuits and it can be used to measure the projected and the actual build material application onto the build surface wherein the control unit (12) or any other direct circuit can thus effect a change in any of the other methods parameters like travel speed of the build material deposition unit, the build surface etc.

A “force sensitive means” in the sense of the disclosure can be any means, sensor or part capable of measuring a force applied to a surface, part or area of the apparatus used in a method according to the disclosure. E.g., it can be a force sensor. In a preferred embodiment according to the disclosure the force sensitive sensor is connected to the build surface, and preferably it is also connected to the control unit, preferably determining whether there is a mechanical collision, e.g., due to human intervention or due to an error in the movement of one or more apparatus means.

A “build material deposition unit head nozzle output position” in the sense of the disclosure is to be understood as a point or area where the build material leaves said unit before deposition onto the build surface.

An “imaging system” in the sense of the disclosure is to be understood as any imaging or picture-taking device. In one aspect such a system can visualize, and preferably integrate, the build material that is being set free from the depositing unit and deposited onto the build surface or the prior track of material, and preferably directly or by way of a control unit locally or a central control unit (12) vis-à-vis a projected material 2D or 3D appearance and preferably as a result of the integration, i.e. comparison of such images, it can feed back and effect a change in any method parameter useful to control the printing job, like traveling speed of the X-, Y- Z-axis, deposition volume or/and mass flow of build material etc., or/and effect to initiate, change or stop process steps or additional process steps, like deposition speed, the cooling rate, build material layer thickness,

A “control unit” in the sense of the disclosure is to be understood as a unit wherein information received from one or more measuring means of the apparatus is feed in and preferably integrated and which is used to control one or more process steps. In particular the control unit can be a de-central or central control unit (12) wherein the projected and the actual process parameters can be integrated and the various method parameters controlled, i.e. effected, i.e. initiated, stopped, reduced, or increased. In particular, the control unit integrates the feed in of the weighing means or weighing cell, the balance, the membrane or tactile pressure means, or/and the imaging system. Thus it is possible to perform a comparison of the projected build material to be deposited onto the build surface (and the tracks already deposited) and the actual deposition of build material. Preferably the volume flow or mass flow of said build material is calculated and compared and can thus be controlled to be maintained in a nearly or optimized range. E.g. an up to −50% lower measured mass over a predetermined timeframe can be countered by increasing the mass deposition rate by increasing the speed of the motor of the build material deposition unit. A surplus of measured mass by +15% can by be countered by reducing the speed of the motor of the build material deposition unit. This mass flow correction can occur instantaneously or gradually over an extended time frame between one minute and several hours or days. In this manner it is now possible to increase the quality of the solid 3D object and to receive solidified 3D objects which are very close or essentially resembling the projected solid 3D object. At least it is now possible, e.g., in case of a very long print job being continued, e.g., over night printing, and performed even if no personnel is present to have the print job automated with regards to the print parameters or to have the print job automatically stopped if the projected print parameters, like build material deposition, deviates too much from the projected range. Hence the apparatus and method according to the disclosure can improve the quality or save costly material and time by way of effecting or stopping entirely the print job saving costly material.

“Algorithm” in the sense of the disclosure is to be understood as a program, that is temporarily or permanently executed on a computing device. The algorithm can read sensor data or data from other executable programs such as the machine path and change values in other programs or control variables to affect hardware components.

Further details of the disclosure will be illustrated in the following.

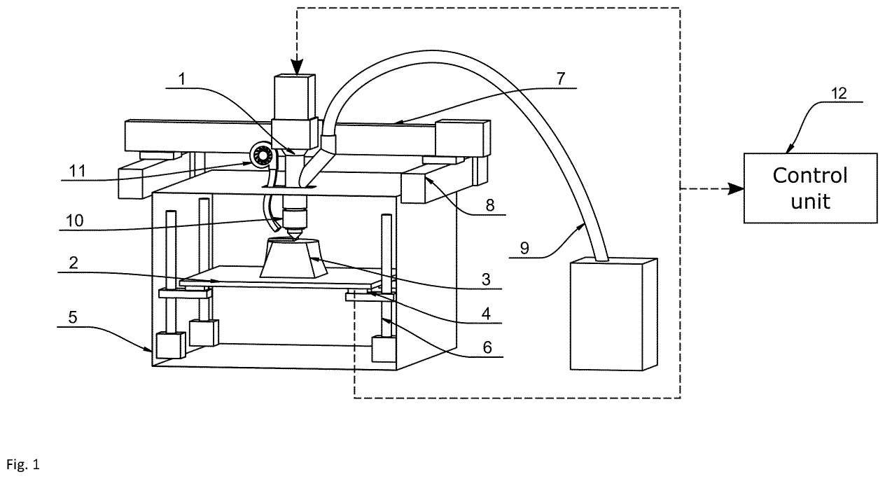

In particular FIG. 1 shows an apparatus according to the disclosure and which can be used for performing the method according to the disclosure. The build material is fed by granulate conveyer (9) into the material deposition unit, in this embodiment an extrusion print head (1), which is actuated to travel in x-axis (7) and y-axis (8). The movement of the extrusion print head (1) is effected by way of one or more motors which may be connected with the control unit (12). In the current embodiment the build surface (2) can travel in the z-axis (6) up and down; during the build job the build surface (2) is lowered from a 0-positon used for calibration purposes, e.g., by way of onto bed leveling, during the build job. The z-axis traveling is also effected by way of a motor which may be connected with control unit (12). One or more balance means, i.e. 1, 2, 3, 4, 5, 6 or more, e.g. a weighing cell (4), is connected with the build surface (2). This can be underneath the build surface (2) or in connection with the z-axis at the position(s) where the build surface (2) is in connection with the post for traveling the build surface (2). It is also possible that the weighing means is positioned between the connection of the print bed with the print surface (2) and the z-axis (6) is a balance (4) which either partly or completely takes the weight of the print bed with the print surface (2).

Alternatively, one or more, e.g. 2, 3, 4, 5, 6 or more weighing cells (4) can be positioned within the build surface (2) which is designed as a double layer wherein the weighing cells are positioned between an upper surface onto which the build material is deposited and a lower layer in which two layers form the integrated build surface (2). This double layer build surface (2) is designed in a way so that the upper surface can freely move or is not fixed in the sense that the weighing cells can measure a mass change of either build material deposited thereon or in case there is a collision of the build material deposition unit with the build surface (2) or the build material already deposited onto the build surface (2).

In yet another embodiment of the disclosure, the weighing cells (4) can be positioned below the entire device to measure the amount of material transported to the device from a separate build material reservoir e.g., the granulate conveyor (9).

The weighing means can also be used to perform the onto bed leveling procedure which is performed before a print job is started in order to calibrate the apparatus. The onto bed leveling procedure can thus be advantageously performed without the need of any additional measuring means. The build material deposition unit, e.g., the extrusion print head, can be directly moved to different predefined positions and lowered onto the build surface (2) in order to perform the leveling step.

Build material (print material) is supplied to the extrusion print head by a granulate conveyor (9) as is well known be the skilled person according to standard procedure. The build material (as a granulate still) is pushed to the extruder nozzle by way of an extruder screw that is sitting in a barrel of the extrusion print head and wherein the extruder screw is actuated by a motor; the motor may be connected to the control unit (12), and thus the extrusion speed can be controlled and adapted together with other parameters during the print job. The build material is thermally liquefied in the extrusion print head by heating mean (10). The build material again solidifies once pushed out of the extrusion print head nozzle to the predefined area and thus contributes to building a solid object (3).

In an alternative or additional aspect of the disclosure the solidification speed/rate of the build material may be controlled by controlling the internal temperature in case one uses a closed build chamber. The temperature of the closed build chamber (5) may contain additional temperature control means and temperature control sensors. For example a cooling unit (11), e.g. a cooling fan, may blow cold air onto the freshly deposited track of build material and thus accelerate the solidification process of the build material. Of course, the cooling unit (11) may also by placed inside the build chamber (5) or a second cooling unit may be placed inside the build chamber to improve air circulation in the build chamber (5) and thereby increase heat exchange between the printed object (3) and the environment.

The basic working principle according to the disclosure of the weighing means is as follows. A scale is used to measure the weight of the printed solid object or the build material deposited onto the build surface before, during and/or after the print procedure. The scale can either be placed below the print bed or below the printer itself, e.g., if the printing material is supplied from outside the printer. In any case, the scale is measuring the amount of processed mass deposited onto the build surface (2) in the build chamber (5). The scale could also be positioned near the material supply and measure the reduction of the material that is processed by the print head.

Preferred aspects or/and embodiments of the disclosure are described in the following.

In one aspect the method according to the disclosure can be applied before a print job for providing a simple and reliable calibration method. In particular an onto bed leveling process step, i.e. a leveling procedure, is performed before the printing process is started.

In one aspect the method according to the disclosure a measuring means is used for measuring the build material quantity, wherein the measuring means is a balance connected to the build surface or a measuring means connected to the material deposition unit nozzle output position, or an imaging system, preferably recording the build material deposition process between the material deposition unit nozzle output position and the deposition area on the build surface and earlier deposited layers of build material.

In one aspect in the method according to the disclosure forces impacting on the build surface can be measured. In particular, for measuring the force applied to the build surface a force sensitive means, preferably one or more force sensors, are connected to the build surface. Preferably which force sensitive means is also connected to the control unit, preferably determining whether there is a mechanical collision, e.g., due to a human intervention as an unintended contact with any apparatus means or due to an error in the movement of one or more apparatus means.

In one aspect the method according to the disclosure implies determining or/and effecting a variation of one or more method steps or parameters which may be useful for improving the print method and/or the quality output of the printed object. In particular, one can by using the method of the disclosure initiate or change one or more process steps or parameters comprising changing the material output rate, changing the deposition speed, changing the cooling rate, changing the build material layer thickness, changing the temperature, preferably changing the heating elements settings interacting with the material or the ambient temperature surrounding the printed object.

In one aspect the method according to the disclosure can apply any build material compatible with the other method and/or apparatus features and parameters, and the build material setup may vary depending on the other method parameters. In particular, the build material can be selected from a filament, pellets, a liquid or a slurry.

In one aspect the method according to the disclosure the build material can be selected from a thermoplastic material such as acrylonitrile butadiene styrene (ABS), polylactic acid (PLA), high-impact polystyrene (HIPS), thermoplastic polyethylene (TPE), polyether ether ketone (PEEK), polyether ketone ketone (PEKK), polyaryl ether ketone (PAEK), polyether imide (PEI), polycarbonate (PC), acrylonitrile styrene acrylate (ASA), polyethylene terephthalate (PET), polyethylene terephthalate glycol (PETG), polybutylene terephthalate (PBT), polyphenylene sulphide (PPS), polyphenyl sulfone (PPSU), polymethyl methacrylate (PMMA), polypropylene (PP), thermoplastic polyurethane (TPU) or/and aliphatic polyamides (PA) or/and a mixture of these materials, or/and a blend of these materials with organic or inorganic additives like glass fibers, carbon fibers, basalt fibers, glass beads, metal particles, ceramics, carbon nano tubes, or/and a thermoset material like curable resins, or/and viscoelastic liquids like concrete or chocolate or binders. In one aspect the method according to the disclosure can apply a control unit (12) and said control unit can preferably integrate the measuring process step and its measuring results or output and the effecting process steps, preferably wherein the integration is performed using one or more algorithms.

In one aspect the method according to the disclosure the algorithm can be characterized as follows:
1. In a first step, an analog to digital conversion of the sensor data is performed either within the measuring device or within the control unit.
2. Receiving the data in a control unit and storing the sensor data or a result of a calculation performed with the raw data of the digital sensor values of a defined time frame.
3. Comparing the values derived from the measurement with the volume or mass that was requested by the to be executed machine path code, preferably a G-Code format.
4. Making a decision with respect to predefined threshold levels of the result of the previous step.
   a. If a measured value is 0% to 30% higher or lower than a requested value, change a control variable in its value according to a directly or inversely proportional, exponential, logarithmic or polynomic function of the difference of the values. Alternatively, a combination of these functions or according to values predefined in a look-up table. The value of the control variable is changed until measured and requested value are equal. Alternatively, mathematically calculated derivatives or integrals of the input values form the measurement and the requested value may be used for the correct adjustment of the control variables. Control variables can be motor speeds, temperature control means, axis positions as defined in claim XXX.
   b. If a measured value is 30% to 100% higher or lower than a requested value, perform an action according to a routine that can be pre-defined or partially pre-defined and partially real-time-value-based e.g., on weight, pressure or camera image derived values. Typical actions can be pause or stop the print process.
   c. If the number of corrections that were performed during one print reaches a value which indicates that part quality is severely affected and a new print job is preferred over continuing the current print job, the current process should be stopped.
   d. If the value of the to-be corrected control variable exceeds a limit that is either unplausible or limited by physical or mechanical constraints, an action should be performed to prevent harm to the print object, mechanical parts or other involved objects or persons.
5. End the program or continue at one of the previous steps.

In one aspect the modeling apparatus according to the disclosure can contain one or more measuring means. In particular the measuring means for measuring the build material deposited onto the build surface is a balance connected to the build surface, or a measuring means connected to the material deposition unit nozzle output position, or an imaging system recording the build material deposition process between the material deposition unit nozzle output position and the deposition area on the build surface and on earlier deposited layers of build material, or a force sensitive means, preferably a force sensor, connected to the build surface.

In one aspect the modeling apparatus according to the disclosure the balance is connected to the build surface by way of one or more weight sensors.

In one aspect the modeling apparatus according to the disclosure can exhibit a special positioning of the weight sensors. In particular the one or more weight sensors can be positioned at each of the corners of the build surface or in a regular spacing on, at or under the build surface.

In one aspect the modeling apparatus according to the disclosure the control unit can be connected to one or more components of the apparatus selected from the print bed, the measuring means, the build material supply means, the material deposition unit including an actuator for material deposition the traveling means, preferably of the X-, Y- or/and Z-axis, the heating means, and the cooling means and the measuring means.

In one aspect the modeling apparatus according to the disclosure an algorithm can be useful in a method as disclosed herein or/and an apparatus as disclosed herein wherein the algorithm is characterized in

[symbol]

The information of mass or force acting upon the print bed can be used in the following ways:

1. Before a print job:
i) Automatically calibrate the mass flow for a new material or new settings like new heating temperatures or new part cooling fan speed or new environment temperature by measuring the mass flow (weight increase over time intervals) with the scale for a number of requested mass flows (or motor speeds).
ii) Safety Check to see if there is a person or a part on the build platform which would cause a collision or injury.
iii) Levelling procedure:
   (1) move the print head to different X/Y positions (preferably grid points).
   (2) For each position move the print bed to collide with the print nozzle and stop or reverse the Z motion once a force or weight was detected by the sensor.
   (3) Store the X, Y and Z coordinates where the nozzle touched the print bed in the control unit.
      (a) The height map can now be used to self-align the bed, if the z-motion is performed by more than one actuator that can be controlled individually. E.g., lower one side of the bed and elevate the other to correct a bed tilt. If three or more actuators are present, also a twist in the bed surface can be corrected.
      (b) The height map can also be used to assure an even layer height for the first (and consecutive) layers by adding the variable Z-offset to the X/Y tool path of the first layer.
iv) Tactile measurement:
   (1) An object positioned on the print bed can be measured by measuring a force variation during a collision between the print head and the object and storing the respective coordinate information.

2. During a print job: the control unit compares the requested (projected) weight (from tool planning) with the actual deposited weight during a print at different times
i) After a specified threshold of deviation is exceeded, a pre-programmed action is executed, which again can be one of the following:
   (1) Rotate the extruder motor faster or slower in proportion to the mass flow deviation.
   (2) Pause the print job and wait for a user input.
   (3) Cancel the print job if the deviation reached an even higher threshold level and severe underextrusion has already happened.
   (4) Cancel the print if a deviation occurred to many times during one print job.
   (5) Trigger an alarm signal or output an error message.
   (6) Execute other pre-programmed routines (e.g. move to an unused area of the print volume, extrude very fast until the error is corrected, cool and/or heat the heating elements to a certain level in a certain order, perform certain movements that can induce vibrations to the system to loosen up material by vibrations).
ii) Position of an object: if equipped with several sensors, the weight distribution can be used to determine the position of an object. Which may be useful for process monitoring. For example, it can be detected if the object became loose from the print bed.
iii) Detect print defects: An accumulation of material is usually passed on through several layers. Which shows as a repetitive pattern on the weight sensors and indicates that in this region of the part there is under- or over extrusion, or a curling effect happening. Curling is the effect of unwanted lifting of printed lines due to polymer shrinkage. E.g., Curling at overhanging edges of the component leads to an increased pressure of the nozzle tip on the object hence the print bed.

3. After a print job: Store the measurement and/or correction data for later use and documentation of manufacturing data for quality assurance purposes.

4. At all times: the measuring and integration of the weight or mass change relating to build material deposited onto the build surface can be used as a safety function to stop the Z-movement when a sudden force change is detected. E.g. when moving the print bed in one direction and a collision occurs. Especially when moving the print bed down and a body part is positioned below the print bed a personal injury can be prevented.

### REFERENCE LIST

| Reference | Reference | |
|---|---|---|
| number | part | Description |
| 1 | extrusion | e.g. a liquefying unit (extrusion unit) to |
| | print head | process the build material (print material) |
| 2 | build | the surface to build a 3D object which is |
| | surface | also denoted build bed and is comprised |
| | | within the build chamber |
| 3 | printed | additively manufactured part (solid 3D |
| | object | object) |
| 4 | weighing | force sensitive sensor to detect forces |
| | cell | acting upon the print bed |
| 5 | build | preferably an enclosure that may be heated |
| | chamber | to maintain a constant temperature |
| | | surrounding the part for better part quality |
| 6 | Z axis | means to provide linear motion in the Z axis |
| 7 | X axis | means to provide linear motion in the X axis |
| 8 | Y axis | means to provide linear motion in the Y axis |
| 9 | granulate | material supply unit, in one embodiment a |
| | conveyor | venturi nozzle equipped with a pneumatic valve |
| | | that blows granulate from a reservoir and |
| | | through a flexible tube to the extrusion unit |
| 10 | heating | in one embodiment heating belt to provide |
| | means | thermal energy for the liquefaction of the |
| | | thermoplastic material |
| 11 | cooling | in one embodiment radial blower fan to provide |
| | means | cool air focused on the freshly deposited |
| | | track for quicker and controlled solidification |
| 12 | control | means for integrating and effecting process |
| | unit | parameters |

1. A method for producing a solid object using a modeling apparatus, e.g. a fused deposition modeling (FDM) apparatus, or a multi-jet-modeling (MJM) apparatus, or a fused filament fabrication (FFF) apparatus, or a stereolithography apparatus (STL), comprising a build material deposition unit including a nozzle for depositing build material, a build surface, preferably any additional means useful in said method or apparatus, comprising or consisting of the following steps:
a. depositing the build material with the extruder head onto the build surface on predefined areas in a first level;
b. repeating step a.) in a second level and preferably further levels;
c. repeating steps a.) and b.) so long until the solid object is built;
d. measuring the build material quantity applied to the build surface, preferably during the build material is deposited onto the build surface, or after each level of build material has been deposited on the build surface, or measuring a force applied to the build surface;
e. preferably comparing the build material quantity deposited onto the build surface with the build material projected to be deposited onto the build surface during deposition, or for each level of build material deposited onto the build surface;
f. effecting, e.g. reducing, increasing or stopping, the build material deposition based upon step d.) and/or e, or effecting, e.g. initiating or changing, at least process step or parameter.

2. The method of claim 1, wherein an onto bed leveling process step (leveling procedure) is performed before the printing process is started.

3. The method of claim 1, wherein for measuring the build material quantity a measuring means is used, wherein the measuring means is a balance connected to the build surface or a measuring means connected to the material deposition unit nozzle output position, or an imaging system, preferably recording the build material deposition process between the material deposition unit nozzle output position and the deposition area on the build surface and earlier deposited layers of build material.

4. The method of claim 1, wherein for measuring the force applied to the build surface a force sensitive means, preferably a force sensor, is connected to the build surface, preferably which is also connected to the control unit, preferably determining whether there is a mechanical collision, e.g. due to human intervention or due to an error in the movement of one or more apparatus means.

5. The method according to claim 1, or wherein initiating or changing another process step or parameter comprising changing the material output rate, changing the deposition speed, changing the cooling rate, changing the build material layer thickness, changing the temperature, preferably changing the heating elements settings interacting with the material or the ambient temperature surrounding the printed object.

6. The method of claim 1, wherein the build material is selected from a filament, pellets, a liquid or a slurry.

7. The method according to claim 6 wherein the build material is selected from a thermoplastic material, a thermoplastic material with filling material, or thermoset materials, preferably a thermoplastic material such as acrylonitrile butadiene styrene (ABS), polylactic acid (PLA), high-impact polystyrene (HIPS), thermoplastic polyethylene (TPE), polyether ether ketone (PEEK), polyether ketone ketone (PEKK), polyaryl ether ketone (PAEK), polyether imide (PEI), polycarbonate (PC), acrylonitrile styrene acrylate (ASA), polyethylene terephthalate (PET), polyethylene terephthalate glycol (PETG), polybutylene terephthalate (PBT), polyphenylene sulphide (PPS), polyphenyl sulfone (PPSU), polymethyl methacrylate (PMMA), polypropylene (PP), thermoplastic polyurethane (TPU) or/and aliphatic polyamides (PA) or/and a mixture of these materials, or/and a blend of these materials with organic or inorganic additives like glass fibers, carbon fibers, basalt fibers, glass beads, metal particles, ceramics, carbon nano tubes, or/and a thermoset material like curable resins, or/and viscoelastic liquids like concrete or chocolate or binders.

8. The method of claim 1, wherein a control unit (12) integrates the measuring process step and the effecting process steps, preferably wherein the integration is performed using one or more algorithms.

9. A modeling apparatus comprising a build material deposition unit, a build surface, preferably in a build chamber, travelling means for the extruder head and/or the build surface, build material supply means, and a measuring means for build material deposited onto the build surface or a force applied to the build surface.

10. The modeling apparatus according to claim 9 wherein the measuring means for measuring the build material deposited onto the build surface is a balance connected to the build surface, or a measuring means connected to the material deposition unit nozzle output position, or an imaging system recording the build material deposition process between the material deposition unit nozzle output position and the deposition area on the build surface and on earlier deposited layers of build material, or a force sensitive means, preferably a force sensor, connected to the build surface.

11. The modeling apparatus according to claim 10, wherein the balance is connected to the build surface by way of one or more weight sensors.

12. The modeling apparatus according to claim 11, wherein the one or more weight sensors are positioned at each of the corners of the build surface or in a regular spacing on, at or under the build surface.

13. A modeling apparatus of claim 18, wherein the control unit is connected to one or more selected from the print bed, the measuring means, the build material supply means, the material deposition unit including an actuator for material deposition the traveling means, preferably of the X-, Y- or/and Z-axis, the heating means, and the cooling means and the measuring means.

14. An algorithm useful in a method of claim 1.

15. The method of claim 1, wherein the method includes the step of comparing.

16. The method of claim 1, wherein the measuring of the build material quantity applied to the build surface, is during the build material being deposited onto the build surface, or after each level of build material has been deposited on the build surface.

17. The method of claim 1, wherein step (d) comprises measuring the force applied to the build surface.

18. The modeling apparatus of claim wherein the apparatus includes a control unit.
